(19) United States
(12) Patent Application Publication
(10) Pub. No.: US 2006/0121170 A1
(43) Pub. Date: Jun. 8, 2006

(54) Rubbery gels made from vegetable oils

(76) Inventor: David L. Howard, Longmont, CO (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 11/006,462

(22) Filed: Dec. 6, 2004

(51) Int. Cl. A23L 1/05; A23D 9/00

(52) U.S. Cl. 426/573; 426/601

(57) ABSTRACT

In one embodiment, the invention is a nonflowable gel composition including a vegetable oil and a thermoplastic elastomer. The nonflowable gel composition is characterized by its inability to flow when subjected to pressure. In another embodiment, the invention is a resilient gel composition including a vegetable oil and a thermoplastic elastomer. The resilient gel composition is characterized by its ability to recover its size and form following deformation. In another embodiment, the invention is a support surface for supporting the human body, including the composition and a holding structure for holding the composition.

### BACKGROUND OF THE INVENTION

This invention relates in general to gel products. In particular, the invention relates to nonflowable vegetable oil compositions that can be formulated as rubbery gels. The invention also relates to support surfaces for supporting the human body, particularly seating pads, that include the rubbery gels. The invention also relates to foams, elastomers and plastics made from vegetable oils.

Existing products in the gel market are desirable for many applications, but they have various disadvantages. For example, silicone rubbers and urethanes require chemical fire retardants for many applications to be sufficiently nonflammable for their intended use. Also, silicone rubbers and urethanes are relatively expensive. Water-based gels require a barrier film to prevent drying, which adds to the cost and complexity of the products.

Gels produced by thickening petroleum oils have desirable physical properties and low cost, but the gels are very flammable. This high flammability limits the market potential of petroleum-based gels. For example, petroleum-based gels have been used in novelty products such as “gum-like” sticky spiders and artificial fishing worms where flammability is not an issue.

U.S. Pat. No. 4,369,284 to Chen discloses a gel composition produced by thickening a plasticizing oil such as mineral oil with a triblock copolymer. U.S. Pat. No. 5,407,715 to Buddenhagen et al. discloses an elastomeric composition produced by thickening a plasticizing oil with a triblock copolymer. The compositions disclosed in these patents are highly flammable because of their plasticizing oil base.

U.S. Pat. No. 5,869,164 to Nickerson et al. discloses a composition comprising an oil thickened with a block copolymer. The composition is a viscous, grease-like thixotropic fluid characterized by its: (1) ability to deform by flowing in response to applied pressure, (2) tendency to maintain its shape and position in the absence of applied pressure, and (3) lack of resiliency. These properties contrast with those of a true gel, which is resilient and tends to spring back into place after applied pressure is removed. The invention is primarily directed to the use of diblock copolymers. The patent briefly mentions that triblock copolymers can be also be used, and that the triblock-based composition tends to have a solid, rubber, or gelatin-like consistency rather than a thin grease-like consistency. However, the amount of block copolymer in the composition is limited to not greater than 22%, and the only triblock copolymers disclosed have a linear structure rather than a radial structure. Such a composition would be flowable and would lack resiliency. The patent does not exemplify any compositions containing triblock copolymers.

Science News, Vol. 155, pp. 40-42 (1999) describes the problem of the flammability of plastics and foam materials, particularly in airplane cabins. The article describes various efforts to make the plastics and foam materials less flammable. For example, researchers have modified polystyrene by adding a second polymer and a catalyst, to rearrange the polystyrene molecule, making it less flammable. However, the article states that airplane manufacturers are using the best plastic and foam materials available, and they are still not good enough. In addition, nonflammable plastics and foam materials must have low cost for acceptance in the market.

In view of the above, there is still a need for an improved alternative to the gel compositions currently on the market. It would be particularly desirable to provide rubbery gel compositions that are inherently nonflammable, are low cost, and have desirable physical properties.

### SUMMARY OF THE INVENTION

The present invention provides compositions that are attractive alternatives to the gel, foam, elastomer and plastic compositions currently on the market, particularly rubbery gels. In a first embodiment, the invention is a rubbery gel composition including a vegetable oil and a rubber elastomer. Preferably, the vegetable oil is canola oil. The composition is preferably nonflammable.

In another embodiment, the invention is a nonflowable gel composition including a vegetable oil and a thermoplastic elastomer. The composition is characterized by its inability to flow when subjected to pressure.

In another embodiment, the invention is a resilient gel composition including a vegetable oil and a thermoplastic elastomer. The composition is characterized by its ability to recover its size and form following deformation.

In another embodiment, the invention is a nonflammable, nonflowable gel composition including a vegetable oil and a thermoplastic elastomer. The composition is characterized by its ability to pass the Cal 117 test for nonflammability, and by its inability to flow when subjected to pressure.

In another embodiment, the invention is a biodegradable, nonflowable gel composition including a vegetable oil and a thermoplastic elastomer. The composition is characterized by its ability to be broken down by microorganisms, and by its inability to flow when subjected to pressure.

In another embodiment, the invention is a nonflammable gel composition including a vegetable oil, a thermoplastic elastomer, and a high temperature material having a melting point not greater than 105° C., the high temperature material being selected from the group consisting of high temperature waxes and high temperature plastics. The nonflammable gel composition is characterized by its ability to pass the Cal 117 test for nonflammability In another embodiment, the invention is a support surface for supporting the human body, including a rubbery gel composition and a holding structure for holding the rubbery gel composition. The rubbery gel composition includes a vegetable oil and a rubber elastomer.

Various objects and advantages of this invention will become apparent to those skilled in the art from the following detailed description of the preferred embodiments.

### DETAILED DESCRIPTION OF THE PREFERRED EMBODIMENTS

The compositions of the invention include a vegetable oil, preferably canola oil, thickened with a thermoplastic elastomer, which may include a rubber elastomer and/or a triblock copolymer. The compositions are preferably in the form of a rubbery gel. In preferred embodiments of the invention, the compositions are inherently nonflammable, are low cost, and have desirable physical properties. The compositions of the invention have an elongation, which means that substantial force is required to elongate or stretch the compositions. A gel composition of the invention may have an elongation as little as 10% or as much as 1,000%. In contrast, a fluid composition such as disclosed in the Nickerson et al. patent has no elongation; the fluid simply pulls apart with virtually no force when the fluid is separated by hand. The properties of the compositions of the invention, such as elongation, nonflowability and resiliency are measured at room temperature (72° F.) unless otherwise described.

The formulation and processing of the compositions of the invention are described in detail hereinbelow.

The Vegetable Oil

The compositions of the invention include a vegetable oil. Some examples of suitable vegetable oils include canola, soybean, corn, palm, cottonseed, peanut, olive, coconut, linseed, safflower, sunflower, and other triglyceride oils. Mixtures of different vegetable oils can also be used. In some embodiments, the vegetable oil is used in an amount within the range of from about 20% to about 75% by weight of the composition. In some preferred embodiments, such as some preferred gel compositions of the invention, the vegetable oil is used in an amount within the range of from about 55% to about 75% by weight of the composition.

To reduce the potential for oxidation of the vegetable oil over time, preferably an oxidation-resistant vegetable oil is used in the composition, and/or the vegetable oil is processed to resist oxidation. Canola oil is an example of a vegetable oil that is less susceptible to oxidation than most other vegetable oils. The vegetable oil can be hydrogenated and/or fractionated to provide a lower degree of unsaturation for greater resistance to oxidation. A preferred vegetable oil for use in the composition of the invention is a partially hydrogenated, fractionated canola oil, such as Solo 1000 produced by C&T in Charlotte, N.C. Genetically engineered versions of regular and hydrogenated canola oil, which are particularly robust, are sold by Cargill Foods as Clear Valley 65, Clear Valley 75 and Odyssey 500.

A composition of the invention made with partially hydrogenated, fractionated canola oil was exposed to 80° C. temperature for two months to test for oxidation. Aged samples were analyzed for peroxide value. When vegetable oils are oxidized, peroxide molecules are formed. A ‘rancid’ odor indicates that peroxides are present in the oil. The analysis indicated that the composition would have an estimated lifecycle at room temperature of 100 to 200 years. Thus, chemical breakdown from oxidation is not considered a problem with the compositions of the invention.

If desired, antioxidants can be added to the vegetable oil to further improve the life of the oil. Some examples of suitable antioxidants include BHT, BHA, TBHQ, Irgonox, and hindered phenols commonly used in the manufacture of plastics.

The Thermoplastic Elastomer

The compositions of the invention also include a thermoplastic elastomer. The thermoplastic elastomer can be any elastomer suitable for making compositions according to the invention having the desired physical properties. Some examples of suitable thermoplastic elastomers include block copolymers, rubber elastomers, and blends thereof.

In a preferred embodiment, the composition includes a rubber elastomer alone or in combination with another thermoplastic elastomer. Rubber elastomers are well known in the art. Some specific examples of suitable rubber elastomers include styrene butadiene rubber (“SBR”), ethylene propylene rubber (“EPR”), natural rubber (“NR”), terpolymer elastomer made from ethylene-propylene diene monomer (“EPDM”), terpolymer elastomer made from ethylene-propylene monomer (“EPM”), and butyl rubber.

Depending on the specific composition, the addition of a rubber elastomer such as SBR to a composition containing vegetable oil and a triblock copolymer can strengthen and stiffen the composition considerably. For example, a gel composition can be modified into an elastomer composition such as would be suitable for making elastomeric tubing, or into a plastic composition such as would be suitable for making a plastic film.

In some gel compositions, the gel becomes flammable when the elastomer concentration is about 35% or more. When the composition contains SBS elastomer and/or SBR rubber elastomer, the flammable component in the elastomer is butadiene. The butadiene portion dissolves in the vegetable oil and it is responsible for a gel composition's rubber-like properties. By reducing the percentage of butadiene in the gel composition, the composition is less flammable, and also harder and less elastic. An elastomer with a higher styrene content produces a more plastic-like or less rubber-like material. At least some butadiene, however, is useful for solubility in the vegetable oil. SBS and SBR rubber elastomers are available with butadiene levels not greater than 50%.

The block copolymers include triblock copolymers, diblock copolymers, and blends thereof. In some embodiments of the invention, the compositions include a triblock copolymer alone or in combination with a diblock copolymer or a rubber elastomer. The use of a diblock copolymer or a rubber elastomer in combination with a triblock copolymer may enhance the properties of the composition.

Triblock copolymers have the general configuration A-B-A, where each “A” is a polymer end block that is hard at room temperature but fluid upon heating, and “B” is a polymer center block that is soft or elastomeric at room temperature. Examples of polymers that are suitable for use as the hard block “A” include thermoplastic polymers such as polystyrene, polycarbonate and polyacrylonitrile. Examples of polymers that are suitable for use as the soft block “B” include elastomeric polymers such as polybutadiene, polyisoprene, polyethylene and polypropylene. Other polymers suitable for use as the hard block and the soft block are well known to persons skilled in the art. Some specific examples of triblock copolymers for use in the compositions include polystyrene-polybutadiene-polystyrene (“SBS”), polystyrene-polyisoprene-polystyrene (“SIS”), and polystyrene-poly(ethylene-propylene)-polystyrene (“SEPS”). SBS elastomers are particularly preferred for use in the compositions. Some examples of commercially available SBS elastomers include Shell D-1184, D-1116, D-1102 and D-1107 manufactured by Shell Chemical Co., and EniChem TE 6306, TE 6414 and Sol T161 B manufactured by EniChem America Inc. The Shell D-1184 elastomer contains 84% SBS and 16% polystyrene-polybutadiene (SB) diblock elastomer. The diblock component may improve solubility between the vegetable oil and the triblock copolymer, which improves the strength and other physical properties of the composition.

In some embodiments of the invention, the composition includes the triblock copolymer in an amount within the range of from about 25% to about 80% by weight of the composition. Some embodiments, such as some preferred gel compositions, include the triblock copolymer in an amount within the range of from about 25% to about 45% by weight of the composition. At least about 25% triblock copolymer increases the strength of the composition. This contrasts with the compositions disclosed in the Nickerson patent, which are formulated to lack strength so that they flow when pressure is applied.

In other embodiments, at least about 75% by weight of the triblock copolymers used in the composition have a branched structure rather than a linear structure. The branched structure helps to increase the strength of the composition and reduce the possibility of oil bleeding from the composition. A preferred branched structure is a radial structure.

In other embodiments, the triblock copolymer includes polystyrene as the hard block “A”, and the copolymer has a polystyrene content of at least about 33%. The styrene present in the triblock copolymer may act as a fire retardant in the compositions of the invention, further improving the nonflammability of the compositions.

Numerous types of diblock copolymers can be used in the compositions. Such diblock copolymers are well known in the art. Some specific examples of suitable diblock copolymers include polystyrene-polybutadiene (“SB”), polystyrene-polyisoprene (“SI”), polystyrene-poly(ethylene-propylene) (“SEP”) and polyethylene-polypropylene (“EP”). Diblocks of the previously named triblock elastomers may also be useful. Other suitable diblock copolymers are disclosed in U.S. Pat. No. 5,869,164 to Nickerson et al., which is incorporated by reference herein. SB elastomers may enhance the solubility of SBS elastomers in vegetable oil. Some suitable SB elastomers are sold by Shell Chemical Co. as Shell G-1654X, G-1765X and FG-1901X.

In some embodiments of the invention, diblock copolymers are used in combination with the triblock copolymers in an amount less than about 25% by weight of the composition.

In other embodiments, the composition includes a crosslinkable block copolymer in combination with a noncrosslinkable triblock copolymer or diblock copolymer. The addition of a crosslinkable block copolymer may increase the strength of the composition, and thereby reduce the amount of the triblock copolymer or diblock copolymer needed in the composition. Shell Chemical Co. manufactures two such crosslinkable block copolymers: D-1300X (SBS) and D-1320X (SI). Preferably, the crosslinkable block copolymer is included in an amount within the range of from about 1% to about 80% by weight of the composition. A catalyst or crosslinking agent is also usually added to cause crosslinking of the copolymer. In some embodiments, when the composition includes a crosslinkable copolymer, it may include as little as about 10% by weight of the triblock copolymer or diblock copolymer.

As described further below, incorporating plastic microballoons into a gel composition reduces the density of the gel. However, incorporating plastic microballoons is usually difficult because the process temperature of the gel composition is higher than the melt temperature of the plastic microballoons. The melt temperature of the gel composition must be reduced below 110° C. to prevent softening of the plastic microballoons. One way to reduce the melt temperature of the gel composition is to use a lower molecular weight elastomer alone or in combination with a higher molecular weight elastomer. For example, a preferred elastomer for use in gel compositions of the invention is a Shell D-1184 SBS elastomer, having a molecular weight of approximately 250,000 molecular units. The melt temperature of the composition can be reduced by use of a lower molecular weight elastomer in combination with the Shell elastomer, for example an SBS elastomer having a molecular weight of approximately 90,000 molecular units sold by Dexco. In some embodiments, the total elastomer has an average molecular weight of less than about 250,000 or 275,000.

Plasticizers

In some embodiments, the compositions of the invention include a plasticizer. Depending on the particular composition, the plasticizer can be used to strengthen the composition, improve other properties of the composition, or enhance processing of the composition. A reactive plasticizer such as an epoxy resin, a urethane resin or a PVC resin can strengthen a gel composition, or modify a gel composition into an elastomeric composition or a plastic composition. For instance, reactive plasticizers can be important strengthening additives for making elastomeric compositions such as would be suitable for making elastomeric tubing, or plastic compositions such as would be suitable for making plastic films. Addition of an epoxidized soy resin can strengthen the compositions. Non-reactive plasticizers such as mineral oil, process oil or glycerin can also be added to improve the properties of the composition or enhance processing. Plasticizers such as aromatic, aliphatic and naphthenic oils can also be advantageously added to the compositions. Reacted oils such as the three previously described and vegetable oils with side groups can be advantageous. Side groups would include sulfur containing compounds, cyannate, amide, amine, phenol, hydroxyl, carboxylic, hydrocarbons such as methyl and ethyl, and silicon.

Cross-Linking or Vulcanizing Agents, Catalysts, Coupling Agents

In some embodiments, the compositions of the invention include a cross-linking agent or a vulcanizing agent. The cross-linking agent or vulcanizing agent usually strengthens or otherwise enhances the properties of the composition. For instance, a gel composition may include a cross-linking agent to further enhance or strengthen the gel. The addition of a cross-linking agent may also modify a gel composition so that it becomes an elastomer composition or a plastic composition.

Any type of cross-linking agent, vulcanizing agent, or mixtures thereof can be added to the composition to enhance its properties. Such cross-linking agents and vulcanizing agents are well known in the art. Some examples of suitable cross-linking agents include sulfur compounds, zinc oxide, calcium carbonate, stearic acid, TMTD, TBBS, DTDM, ZDBDC and peroxides. The carboxylic ends of vegetable oils could be cross-linked with quaternary ammonium salts, which would improve gel strength and reduce oil bleed. Chemicals that prevent “scorching” or premature cross-linking in the mold may also be beneficial.

Cross-linking agents that melt when burned are advantageous over non-melting agents for reducing flammability. Such cross-linking agents include sulfur and stearic acid. Peroxide cross-linking agents form an amines during the cross-linking reaction, which may impart flame retardant properties to the composition. Some cross-linking agents are advantageous for processing because they cure at low temperature.

The cross-linking agent can be chosen so that it is selective for a specific component of the composition. This is advantageous for selecting desirable strength and/or biodegradable characteristics. For example, the cross-linking agent may cross-link the thermoplastic elastomer without cross-linking the vegetable oil. A composition with a highly cross-linked elastomer and a non-cross-linked vegetable oil produces a strong material that breaks down readily in the environment. If the vegetable oil was cross-linked, breakdown in the environment takes much longer. Thus, a variety of physical properties and/or biodegradable characteristics for the compositions are possible by adjusting cross-linking agent makeup and concentration.

A cross-linking catalyst may also be useful in the composition, such as a Ziegler-Natta catalyst or other catalysts well known in the art.

Coupling agents can be used instead of cross-linking agents in minor amounts, e.g., at a level of 0.2% in a plastic composition of the invention. Metallocene catalysts or polymer blends catalyzed with metallocene catalysts are useful. Physical properties of a polymer such as strength can be enhanced with addition of metallocene compounds.

Radiation, light, microwave, x-ray, heat and pressure can induce cross-linking. These processes can strengthen a polymer or polymer blend.

Vulcanized Vegetable Oil

Cross-linking the vegetable oil strengthens the composition. Depending on the specific types and levels of ingredients, the composition is a strengthened gel, an elastomeric composition or a plastic composition. The cross-linking of the vegetable oil can be accomplished with addition of a vulcanizing agent to the composition, or with the addition of a pre-vulcanized vegetable oil called a “factice”. Factice is a rubber-like product made by reacting vegetable oil with sulfur chloride or another vulcanizing agent. Factice is commercially available from Lefrant-Rubco, France, and from Puneet Polymers, a division of Rishiroop, 65, Atlanta, Nariman Point, Mumbai, India. When a vulcanized vegetable oil is added to the composition, the amount of thermoplastic elastomer added can be significantly reduced, thereby reducing the material cost of the composition.

Other Additives

In some embodiments of the invention, the composition includes a high temperature wax or a high temperature plastic. “High temperature” means a wax or plastic having a melting point greater than 105° C. The high temperature wax or plastic functions as a fire retardant, further reducing the flammability of the compositions. Preferably, the wax is an amide wax. An example of a preferred wax is P285 wax manufactured by CasChem, which is a hydroxy bis stearamide wax. Preferably, the amount of high temperature wax is within the range of from about 2% to about 10% by weight of the composition, and more preferably about 5%. In the Science News article previously mentioned, foam urethane seating cushions are covered with Kevlar plastic to reduce flammability. Kevlar is described as an aromatic amide in the Concise Encyclopedia of Polymer Science and Engineering, Wiley, 1990. Although not aromatic, the P285 amide is similar to Kevlar plastic. The P285 wax's amide structure contributes to its non-flammable nature. Kevlar plastic powder, used as a replacement for P285, would reduce flammability in a gel, foam or plastic material of the invention. Other high temperature plastics may also function as fire retardants.

A lipid, lecithin, present in vegetable oils can function as a fire retardant. If desired, additional lecithin can be added to the composition. The lecithin consists of molecular components found in many fire retardant compounds: carboxylic acid, nitrogen and phosphate groups. Lecithin can also act as a mold release agent.

If desired, the compositions can include microballoons to reduce the density of the compositions. As known in the art, microballoons are small, hollow, low-density particles of film-forming materials such as plastic or glass. Usually, the microballoons are discrete micro-sized particles having a diameter within the range of from about 10 to about 300 microns. It is generally preferred to use from about 2% to about 4% plastic microballoons or from about 5% to about 40% glass microballoons, by weight of the composition. Suitable plastic microballoons are sold by Nobel Industries under the commercial name Expancel 091 DE, Expancel 461 DE and Expancel 551 DE. Glass microballoons are less preferred, because the addition of non-melting solid particles such as glass microballoons is minimized to avoid increasing the composition's flammability.

A fire retardant can be added to the composition to make it even more nonflammable. For example, a fire retardant can be added to ensure that the composition passes the Cal 133 test for nonflammability (California Technical Bulletin 133 Flame Ignition Resistance Test, January 1992, entire document), in which numerous newspapers are used as a fuel source over the material to be tested. Examples of suitable fire retardants include melamine, melamine di-borate, ammonium octamolybdate, zinc borate, hydrated borax, brominated aromatic, brominated aliphatic, magnesium hydroxide, brominated polystyrene, zinc molybdate, magnesium sulfate, bismuth subcarbonate, alumina trihydrate, antimony pentoxide, and others well known in the art. Intumescent flame retardants can also be used. Plastic coated fire retardants such as Exolit Hostaflam AP462, an ammonium polyphosphate, minimize potential skin irritation or sensitivity. Hoechst Celanese makes this product. A charring agent such as Perstorp's pentaerythritol is also beneficial. Because the preferred compositions of the invention include a vegetable oil instead of a petroleum-based oil, the compositions usually require not more than about 5% fire retardant by weight for the compositions to pass the Cal 133 test. In contrast, a petroleum-based gel composition such as disclosed in the above-mentioned Chen patent would usually require 30% or more fire retardant to pass the Cal 133 test.

The gel compositions of the invention can include a freeze point depressant so that the compositions remain flexible at lower temperatures. Examples of preferred freeze point depressants for use in the compositions include derivatives of polymethylmethacrylate (RohMax 171, sold by Rohm-Haas), and glyceryl monooleate (sold by AC Humco and Stepan). Other suitable freeze point depressants include conventional antifreeze materials such as propylene glycol, ethylene glycol, methanol and methoxypropanol.

Other possible additives include components that minimize oil bleed, such as glycerin. It is sometimes advantageous to blend other rubber materials into the compositions. Oils other than vegetable oils and the above-described plasticizers are sometimes beneficial in the compositions; such oils are well known in the art. Other possible additives include antidegradants, cure accelerators, process aids and colorants, and fillers such as carbon, fibers, waxes, talc, clays, colloidal silica, detackifying layers, foaming facilitators, tack modifiers, plasticizer bleed modifiers, melt viscosity modifiers, melt temperature modifiers, tensile strength modifiers, and shrinkage inhibitors.

Resins and/or tackifiers can be added to enhance the gel properties. Resins may improve various material properties such as builds tack to improve mineral filler binding, elongation, tensile strength, and flex-crack. Resins may be in the form of aromatic resins, cycloaliphatic resins or phenolic resins. One supplier of these materials is Akrochem of Akron, Ohio. Resins of interest include Petro-Rez 100, Petro-Rez 801, and P-03 resin. If added, the resin and/or tackifier is preferably used in an amount of up to about 20% by weight of the total composition, more preferably about 2% to about 10%, and most preferably about 5%.

Any or all of the formulations described herein can use one or a combination of reactive agents. The concentration of these components is preferably less than about 2%. Some nonlimiting examples of reactive agents include sulfur chloride, stearic acid, zinc oxide, peroxide catalyst, metallocene coupling agent, and sulfur.

Elastomer (Rubbery) Compositions

The composition of the invention can also be produced as an elastomeric or rubbery product. In some embodiments, the elastomer composition is not cross-linked as in a typical rubber, and consequently the composition can be easily remelted or recycled. Lack of cross-linking may be another factor that contributes to the low flammability of the preferred compositions. Suitable formulations that could be produced for elastomer compositions according to the invention are shown below:

### Elastomer Composition

The following components were made into an elastomer composition:

| Components | Percentage |
|---|---|
| Hydrogenated/fractionated canola oil | 25% |
| EniChem TE 6306 | 75% |
| Antioxidant, BHT | 0.5% |

### Rubber Addition

The following components can be made into an elastomer composition:

| Components | Percentage |
|---|---|
| Hydrogenated/fractionated canola oil | 65% |
| SBS elastomer | 25% |
| SBR rubber | 10% |
| Antioxidant, BHT | 0.5% |

(The SBR rubber can be substituted with SEBS.)

### Factice Addition

The following components were made into an elastomer composition:

| Components | Percentage |
|---|---|
| Hydrogenated/fractionated canola oil | 15% |
| Factice | 50% |
| SBS elastomer | 25% |
| SBR rubber | 10% |
| Antioxidant, BHT | 0.5% |

The elastomer composition is suitable for use as a tire rubber as well as other applications. The tire rubber can be remelted for recycle.

### Gel Compositions

The gel composition is a true gel that springs back into place after compressive forces are removed. Preferably, the gel composition has a hardness on the Shore A scale of less than about 15, and more preferably less than about 5. Some suitable formulations for gel compositions according to the invention are shown below:

### Gel with Two Elastomers

The following components were made into a rubbery gel:

| Components | Percentage |
|---|---|
| Hydrogenated/fractionated canola oil | 70% |
| Shell D1184 | 21% |
| Dexco, 52705, SBC elastomer | 9% |
| Antioxidant, BHT | 0.5% |

### Flexible Gel

The following components were made into a flexible gel:

| Components | Percentage |
|---|---|
| Hydrogenated/fractionated canola oil | 75% |
| EniChem TE 6306 | 25% |
| Antioxidant, BHT | 0.5% |

### Strong Gel

The following components were made into a strong gel:

| Components | Percentage |
|---|---|
| Hydrogenated/fractionated canola oil | 65% |
| EniChem TE 6306 | 35% |
| Antioxidant, BHT | 0.5% |

### Low Temperature Gel

The following components were made into a low temperature gel:

| Components | Percentage |
|---|---|
| Regular canola oil, Clear Valley 75, Cargill | 30% |
| Hydrogenated/fractionated canola oil | 35% |
| EniChem TE 6306 | 33% |
| RohMax 171 | <1% |
| BHT | <1% |

### Low Temperature, Low Flammability Gel #1

The following components can be made into a low temperature, low flammability gel:

| Components | Percentage |
|---|---|
| Regular canola oil, Clear Valley 75, Cargill | 30% |
| Hydrogenated/fractionated canola oil | 35% |
| EniChem TE 6306 | 30% |
| P285, ChasChem | 3% |
| RohMax 171 | <1% |
| BHT | <1% |

### Low Temperature, Low Flammability Gel #2

The following components can be made into a low temperature, low flammability gel:

| Components | Percentage |
|---|---|
| Regular canola oil, Clear Valley 75, Cargill | 30% |
| Hydrogenated/fractionated canola oil | 30% |
| EniChem TE 6306 | 30% |
| P285, ChasChem | 3% |
| AP 462, Hoechst Celanese | 3.5% |
| Pentaerythritol, Perstrop | 1.5% |
| RohMax 171 | <1% |
| BHT | <1% |

### Gel with Triblock/Diblock Blend

The following components were made into a gel:

| Components | Percentage |
|---|---|
| Hydrogenated/fractionated canola oil | 65% |
| Shell D1184 | 35% |
| Antioxidant, BHT | 0.5% |

### Gel with Metallocene Coupling Agent

The following components were made into a gel:

| Components | Percentage |
|---|---|
| Hydrogenated/fractionated canola oil | 77% |
| Shell D1184 | 23% |
| Metallocene coupling agent | 0.1% |
| Antioxidant, BHT | 0.5% |

### Gel with Resin

The following components can be made into a gel:

| Components | Percentage |
|---|---|
| Hydrogenated/fractionated canola oil | 72% |
| Shell D1184 | 23% |
| Petro Rez 801 | 5% |
| Antioxidant, BHT | 0.5% |

The use of UV light, radiation, heat or pressure is an important method for cross-linking the gel matrix. For example, the formulation can be cross-linked by exposure for about one hour to a high intensity UV light at 254 nm or 365 nm to improve the cross-linking of the gel. High intensity UV lamps are available from Cole-Parmer of Chicago, Ill.

### Gel using UV Light for Cross-Linking

The following composition can be exposed to high intensity UV light for one hour to cross-link the gel matrix:

| Components | Percentage |
|---|---|
| Hydrogenated/fractionated canola oil | 77% |
| Shell D1184 | 23% |
| Antioxidant, BHT | 0.5% |

Products that can be made with the gel include bicycle seats, sports and medical products, padding for different applications, such as wheelchair seating cushions and back cushions, and other products known in the art.

The gel compositions of the invention compare favorably with existing products in the gel market, such as silicone rubber, urethanes and water-based gels. The gel compositions can be fabricated with a variety of elongation and strength properties that compare favorably to silicone rubber and urethanes. The gel compositions also have cost advantages over silicone rubber and urethanes. Both silicone rubbers and urethanes require chemical fire retardants for many applications; the gel compositions of the invention are preferably nonflammable without fire retardants. Water-based gels require a barrier film to prevent drying; the gel compositions of the invention resist drying without a barrier film.

Foam Compositions

The composition of the invention can also be produced as a foamed product. The foam composition can be mechanically foamed by injecting a gas into the composition, or chemically foamed by including a blowing agent in the composition. Preferably, the blowing agent gives off a fire retardant gas, such as carbon dioxide or nitrogen, which further improves the nonflammability of the composition. It is believed that some of the blowing agent is unreacted during the foaming process, but is caused to react and give off the fire retardant gas if the composition starts to burn. Examples of preferred blowing agents include Celogen TSH and Celogen 754A sold by Uniroyal Chemicals. A non-hazardous foaming agent is manufactured by Reedy International Corp. and is called Safoam. Other suitable blowing agents are well known in the art. The resulting foam composition includes a continuous phase of the vegetable oil and triblock copolymer, and a dispersed gas phase. The dispersed gas phase usually comprises at least about 30% by volume of the composition. The foam compositions of the invention have properties that exceed those of commercially available urethane foams. Some suitable formulations for foam compositions according to the invention are shown below:

### Sticky Foam

The following components were made into a sticky foam:

| Components | Percentage |
|---|---|
| Hydrogenated/fractionated canola oil | 77% |
| EniChem TE 6306 | 20% |
| Blowing agent, Celogen TSH | 3% |
| Antioxidant, BHT | 0.5% |

### Standard Foam

The following components were made into a standard foam:

| Components | Percentage |
|---|---|
| Hydrogenated/fractionated canola oil | 62% |
| EniChem TE 6306 | 35% |
| Blowing agent, Celogen 754A | 3% |
| Antioxidant, BHT | 0.5% |

### Low Temperature Foam

The following components can be made into a low temperature foam:

| Components | Percentage |
|---|---|
| Regular canola oil, Clear Valley 75, Cargill | 27% |
| Hydrogenated/fractionated canola oil | 35% |
| EniChem TE 6306 | 33% |
| Blowing agent, Celogen 254A | 3% |
| RohMax 171 | <1% |
| BHT | <1% |

### Low Temperature, Low Flammability Foam #1

The following components can be made into a low temperature, low flammability foam:

| Components | Percentage |
|---|---|
| Regular canola oil, Clear Valley 75, Cargill | 27% |
| Hydrogenated/fractionated canola oil | 35% |
| EniChem TE 6306 | 30% |
| Blowing agent, Celogen 754A | 3% |
| P285, ChasChem | 3% |
| RohMax 171 | <1% |
| BHT | <1% |

### Low Temperature, Low Flammability Foam #2

The following components can be made into a low temperature, low flammability foam:

| Components | Percentage |
|---|---|
| Regular canola oil, Clear Valley 75, Cargill | 27% |
| Hydrogenated/fractionated canola oil | 30% |
| EniChem TE 6306 | 30% |
| Blowing agent, Celogen 754A | 3% |
| P285, ChasChem | 3% |
| AP 462, Hoechst Celanese | 3.5% |
| Pentaerythritol, Perstrop | 1.5% |
| RohMax 171 | <1% |
| BHT | <1% |

Examples of products that can be made with the foam composition include pressure relieving seating pads, furniture seating, foam filters, and numerous applications where foam rubber is used. The “sticky foam composition” is particularly suited for use as a pressure relieving seat material, e.g., for wheelchairs, or as a sticky filter material. The “standard foam composition” is particularly suited for use as a seat back in furniture seating.

In preferred embodiments of the invention, the foam composition without a chemical fire retardant compares favorably for nonflammability with a urethane foam loaded with a chemical fire retardant. In a Cal 117 test, the foam composition does not burn or smoke. Chemical fire retardants are potential skin irritants and may produce toxic gases when burned. Smoke is a significant problem in most fires. Thus, the foam composition of the invention provides several advantages over urethane foams.

Plastic Compositions

The composition of the invention can also be formulated as a plastic composition. Increasing the triblock copolymer content and adding a high temperature wax or a high temperature plastic to the composition produces an inherently nonflammable plastic material. Some suitable formulations for plastic compositions according to the invention are shown below:

### Plastic Composition

The following components were made into a plastic composition:

| Components | Percentage |
|---|---|
| Hydrogenated/fractionated canola oil | 45% |
| EniChem TE 6306 | 50% |
| High temp. wax, P285, Chaschem | 5% |
| Antioxidant, BHT | 0.5% |

### Low Temperature Plastic

The following components can be made into a low temperature plastic:

| Components | Percentage |
|---|---|
| Regular canola oil, Clear Valley 75, Cargill | 23% |
| Hydrogenated/fractionated canola oil | 25% |
| EniChem TE 6306 | 50% |
| RohMax 171 | <1% |
| BHT | <1% |

### Low Temperature, Low Flammability Plastic #1

The following components can be made into a low temperature, low flammability plastic:

| Components | Percentage |
|---|---|
| Regular canola oil, Clear Valley 75, Cargill | 20% |
| Hydrogenated/fractionated canola oil | 30% |
| EniChem TE 6306 | 45% |
| P285, ChasChem | 3% |
| RohMax 171 | <1% |
| BHT | <1% |

### Low Temperature, Low Flammability Plastic #2

The following components can be made into a low temperature, low flammability plastic:

| Components | Percentage |
|---|---|
| Regular canola oil, Clear Valley 75, Cargill | 20% |
| Hydrogenated/fractionated canola oil | 25% |
| EniChem TE 6306 | 45% |
| P285, ChasChem | 3% |
| AP 462, Hoechst Celanese | 3.5% |
| Pentaerythritol, Perstrop | 1.5% |
| RohMax 171 | <1% |
| BHT | <1% |

The plastic composition can be used, e.g., as a fabric, a film, or in other applications known in the art.

Tubing and Film Applications

The elastomer compositions of the invention can be manufactured into elastomeric tubing, and the plastic compositions of the invention can be manufactured into plastic films. The gel composition needs to be strengthened and stiffened considerably for tubing or film applications. As discussed above, several gel modifications are possible, including vulcanized vegetable oil, SBR elastomer, selective cross-linking agents, plasticizers, fillers, and combinations thereof. For the film material to compete with commodity thermoplastics such as polyethylene, polypropylene or high density polyethylene, the film is preferably heat sealable so that disposable plastic bags can be manufactured from the film. The film should have sufficient strength, elongation and hardness.

Processing

The compositions of the invention are usually prepared by a process in which the materials are mixed together and heated to form a melted solution. The melted solution is formed into the shape of the desired product and then allowed to cool. For example, the melted solution can be shaped in a mold. One suitable process includes blending the materials together with a mixer such as a Banbury mixer, and pumping the resulting composition through a heated extruder. The composition can be processed with a single or double screw extruder. The melted composition is poured into a mold to form an object. In another process, the triblock copolymer is ground into a fine powder and added to the vegetable oil, then the materials are homogenized in a heated colloid mill to form the melted composition. The composition can also be pelletized and later remelted and formed with typical injection molding equipment and processes.

To make the foam compositions, the compositions can be foamed either chemically or mechanically. A chemical foaming process can be accomplished by adding a blowing agent to the melted solution. The blowing agent is mixed into the melted solution, and the melted solution is then cured in a preheated oven to obtain the desired foam structure. A mechanical foaming process can be accomplished by injecting gas into the melted solution to create a foamed material. Suitable gas injection equipment is also well known in the art.

Advantages of the Composition

In some preferred embodiments of the invention, the composition compares favorably to existing technologies because of its inherent nonflammability, excellent physical properties, and low cost. The primary components of the preferred composition are commodities: hydrogenated/fractionated vegetable oils are used extensively in the food industry, and elastomers such as SBS are additives commonly used in asphalt, tires and adhesives. Since the primary components of the composition are commodities, the material cost is low. The vegetable oil composition of the invention is priced competitively with a petroleum-based composition containing fire retardant.

The use of a vegetable oil in the preferred composition of the invention, instead of a petroleum oil, makes the composition inherently nonflammable. Consequently, there is no need to add fire retardants to the composition. The composition easily passes the Cal 117 test for nonflammability (California Technical Bulletin 117 Flame Ignition Resistance Test, January 1992, encompasses January 1980, Section A, Parts 1 and 2, Section B, Parts 1 and 2, and Section C). In this test, the sample is exposed to a Bunsen burner flame for twelve seconds. The flame must self-extinguish within 60 seconds for the sample to pass the test. The preferred composition of the invention usually self-extinguishes in less than 5 seconds. A foam version of the composition will extinguish more readily than urethane foam loaded with chemical fire retardant. A material that passes Cal 117 is particularly important for personal safety. Flame resistant materials protect an individual from initial burning and allow time to retreat to safety. Also, there is a need for fire resistant materials that do not require fire retardants. Fire retardants often cause skin irritation under normal use, and off-gas toxic fumes when burned. The preferred composition of the invention is non-irritating to the skin, and toxic gases are not released during a burn.

While not intending to be limited by theory, it is believed that several factors may be involved in the low flammability properties of the preferred composition of the invention:
The high flash point vegetable oil interrupts the flame spread from one polymer chain to the next. As a result, the flame spreads less easily between polymers.
Under high heat, the crystalline regions of the polymers disconnect from one another, interrupting the flame spread.
The vegetable oil circulates and transfers heat from high heat regions to low heat regions. Hot spot temperatures are reduced during the initial moments of the burn.
The vegetable oil rises to the surface and comes into direct contact with the flame. The surface area exposed to the flame is reduced by the smooth oil surface.
The high flash point vegetable oil's structure is inherently nonflammable. Oxygen within the molecule interrupts the flame spread. Carbon dioxide may form when the oil burns, which helps to smother the flame.
The composition does not contain solid particles that retain heat during a burn.

The inherent nonflammability of the preferred composition has another benefit: added materials that normally would have an insignificant effect on the flammability of the composition, now function as fire retardants to further improve the nonflammability of the composition. Such materials include the high temperature wax and plastic, the triblock copolymer with high styrene content, the blowing agent that gives off a fire retardant gas, and others. A variety of materials can be added that function as fire retardants in the composition, but that are milder and/or less expensive than conventional fire retardants. In a composition such as disclosed in the Chen patent, the addition of these materials would not significantly affect the flammability of the composition, because the composition is so highly flammable.

Another advantage of some preferred compositions of the invention is that they are more biodegradable than conventional gels, foams, elastomers and plastics. The compositions can be broken down by microorganisms so that they cause fewer problems in the environment. Bacteria in the soil consume vegetable oils. Moisture and trace metals such as iron accelerate the degradation. Double bonded compounds such as butadiene and styrene degrade more readily than saturated plastics such as polyethylene and polypropylene. The P285 wax is derived from a natural wax. Preferably, the compositions of the invention can be broken down in less than 100 years, and more preferably less than 10 years, under the right conditions of bacteria, water, minerals and temperature. Biodegradable materials are in great demand in the marketplace.

Support Surfaces According to the Invention

The invention also relates to support surfaces including the compositions described above. The support surface can be any surface that supports the human body. Some examples include surfaces of furniture, surfaces of airline seating, and surfaces of patient support devices such as wheelchairs, hospital beds, and stretchers. The surfaces can be seats, backs, headrests, thoracic supports, arm rests, foot rests, or any other support surfaces. The surfaces can be in the form of cushions, overlays, or any other suitable form. In a preferred embodiment, the support surface is a support cushion for use in a seating system or a back system of a wheelchair. Different structures for wheelchair support cushions are known in the art, such as those disclosed in U.S. Pat. No. 5,950,263 issued Sep. 14, 1999; U.S. Pat. No. 5,947,562 issued Sep. 7, 1999; U.S. Pat. No. 5,749,111 issued May 12, 1998; U.S. Pat. No. 5,524,971 issued Jun. 11, 1996, and U.S. Pat. No. 5,352,023 issued Oct. 4, 1994; all of which are incorporated by reference herein.

The support surface includes a composition according to the invention, and a holding structure for holding the composition. For example, when the support surface is used in a wheelchair seat or back, the holding structure may be a covering that holds the composition to the frame of the wheelchair. When the support surface is used in furniture, the holding structure may be the upholstery of the furniture. Other holding structures are well known in the art.

Plastic Additives

The compositions of the invention can also be used in minor amounts as additives in making plastics such as nylon, epoxy plastic, styrene plastic, and ABS (acrylonitrile-butadiene-styrene copolymer). The compositions can impart strength, greater flexibility and toughness to the plastic, improve the biodegradability of the plastic, and reduce the flammability and the cost of the plastic. A proper combination of components can create plastic materials that mimic the original plastics. Two plastics that are readily compatible with the gel composition of the invention include ABS and styrene plastic. Various proportions of gel to plastic are possible (the gel in these examples including 70% canola oil and 30% SBS):

| Formula | Plastic | Gel Composition |
|---|---|---|
| 1 | 75% ABS | 25% |
| 2 | 50% ABS | 50% |
| 3 | 25% ABS | 75% |
| 4 | 75% Styrene | 25% |
| 5 | 50% Styrene | 50% |
| 6 | 25% Styrene | 75% |

Non-Flammable Plastic Compositions without Vegetable Oil

The compositions of the invention usually include two components that are important for non-flammability: aromatic phenyl groups and carboxylic acid groups. In the compositions containing canola oil and SBS, the aromatic phenyl groups originate from the SBS, and the carboxylic acid groups originate from the vegetable oil. As an alternative to the use of vegetable oil, the two key components can be blended together from commodity plastic resins, creating non-flammable plastic blends. In addition to being non-flammable, the new materials or plastics are low cost as a result of using readily available plastic resins.

Plastic resins that contribute aromatic phenyl groups include: SBS, ABS and urethane. Plastic resins that contribute carboxylic acid groups and/or beneficial nitrogen groups include: nylon, PMMA, acrylonitrile, urethane and acetal resin. The ratio between aromatic phenyl groups and carboxylic acid groups is important for non-flammability.

Combinations of these resins exist in some commodity thermoplastics. ABS and polystyrene polymers use a variety of copolymers, which enhance strength and flexibility. However, to obtain a non-flammable plastic, the combinations and proportions of different plastics are relatively narrow. The suppliers of these materials are not aware of this. Fire retardants used in their formulations mask the subtle relationship between plastic components. Using the correct plastic ratios eliminates a 30% loading of fire retardants. This increases plastic strength, reduces cost and minimizes toxic chemicals.

Existing styrene copolymers include: styrene-acrylonitrile (“SAN”), acrylate-styrene-acrylonitrile (“ASA”), styrene methyl methacrylate, and polycarbonate (“PC”). The suppliers of these materials include GE, BASF, Monsanto, and Network Polymers. Existing ABS copolymers include: ABS/nylon, and ABS/PC. The suppliers of these materials include: ComAlloy, Novatec, Bayer, Dow and GE.

Copolymers can be added to the plastics, such as copolymers of urethane.

Biodegradable Styrofoam Cups

Addition of vegetable oil to Styrofoam cup formulations could reduce breakdown time from 400 years to less than one year. The vegetable oil would be introduced into the formula with a minor a minor amount of thermoplastic elastomer such as SBS. In conventional Styrofoam cups, the impact properties of the polystyrene are improved by copolymerization or grafting polystyrene chains to unsaturated rubbers such as polybutadiene. Rubber levels typically range from 3 to 12 percent. A 12% rubber makeup is similar to the gel composition of the invention. Addition of vegetable oil will reduce cost and flammability. The Styrofoam cup appearance will be ivory or off-white, not its characteristic brilliant white.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A rubbery gel composition comprising:
a vegetable oil; and
a rubber elastomer.

2. The composition defined in claim 1 wherein the vegetable oil comprises canola oil.

3. The composition defined in claim 1 wherein the composition is nonflammable as characterized by an ability to pass the Cal 117 test for nonflammability.

4. A nonflowable gel composition comprising:
a vegetable oil; and
a thermoplastic elastomer;
the nonflowable gel composition being characterized by its inability to flow when subjected to pressure.

5. The composition defined in claim 4 wherein the thermoplastic elastomer comprises a rubber elastomer.

6. The composition defined in claim 4 wherein the thermoplastic elastomer comprises a combination of a triblock copolymer and a rubber elastomer.

7. The composition defined in claim 4 wherein the vegetable oil comprises canola oil.

8. The composition defined in claim 4 wherein the composition is nonflammable as characterized by an ability to pass the Cal 117 test for nonflammability.

9. The composition defined in claim 4 additionally comprising a material selected from the group consisting of cross-linking agents, vulcanizing agents, coupling agents, and mixtures thereof.

10. The composition defined in claim 4 wherein the vegetable oil comprises a vulcanized vegetable oil blended with a non-vulcanized vegetable oil.

11. A resilient gel composition comprising:
a vegetable oil; and
a thermoplastic elastomer;
the resilient gel composition being characterized by its ability to recover its size and form following deformation.

12. The composition defined in claim 11 wherein the thermoplastic elastomer comprises a rubber elastomer.

13. The composition defined in claim 11 wherein the thermoplastic elastomer comprises a combination of a triblock copolymer and a rubber elastomer.

14. The composition defined in claim 11 wherein the vegetable oil comprises canola oil.

15. The composition defined in claim 11 wherein the composition is nonflammable as characterized by an ability to pass the Cal 117 test for nonflammability.

16. A nonflammable, nonflowable gel composition comprising:
a vegetable oil; and
a thermoplastic elastomer;
the nonflammable, nonflowable gel composition being characterized by its ability to pass the Cal 117 test for nonflammability, and by its inability to flow when subjected to pressure.

17. The composition defined in claim 16 wherein the thermoplastic elastomer comprises a rubber elastomer.

18. The composition defined in claim 16 wherein the thermoplastic elastomer comprises a combination of a triblock copolymer and a rubber elastomer.

19. The composition defined in claim 16 wherein the vegetable oil comprises canola oil.

20. The composition defined in claim 16 wherein the composition is nonflammable as characterized by an ability to pass the Cal 117 test for nonflammability.

21. A biodegradable, nonflowable gel composition comprising:
a vegetable oil; and
a thermoplastic elastomer;
the biodegradable, nonflowable gel composition being characterized by its ability to be broken down by microorganisms, and by its inability to flow when subjected to pressure.

22. The composition defined in claim 21 wherein the thermoplastic elastomer comprises a rubber elastomer.

23. The composition defined in claim 21 wherein the thermoplastic elastomer comprises a combination of a triblock copolymer and a rubber elastomer.

24. The composition defined in claim 21 wherein the vegetable oil comprises canola oil.

25. The composition defined in claim 21 wherein the composition is nonflammable as characterized by an ability to pass the Cal 117 test for nonflammability.

26. A nonflammable gel composition comprising:
a vegetable oil;
a thermoplastic elastomer; and
a high temperature material having a melting point not greater than 105° C., the high temperature material being selected from the group consisting of high temperature waxes and high temperature plastics;
the nonflammable gel composition being characterized by its ability to pass the Cal 117 test for nonflammability.

27. The composition defined in claim 26 wherein the thermoplastic elastomer comprises a rubber elastomer.

28. The composition defined in claim 26 wherein the vegetable oil comprises canola oil.

29. A support surface for supporting the human body, comprising a rubbery gel composition and a holding structure for holding the rubbery gel composition, the rubbery gel composition comprising:
a vegetable oil; and
a rubber elastomer.

30. The support surface defined in claim 29 wherein the vegetable oil comprises canola oil.

31. The support surface defined in claim 29 wherein the composition is nonflammable as characterized by an ability to pass the Cal 117 test for nonflammability.

32. The composition defined in claim 4 wherein the composition is further characterized as being a resilient composition which is able to recover its size and form following deformation.

33. The composition defined in claim 4 additionally comprising a material selected from the group consisting of cross-linking agents, vulcanizing agents, coupling agents, and mixtures thereof.

34. The composition defined in claim 4 wherein the composition additionally comprises microballoons.

35. The composition defined in claim 4 wherein the thermoplastic elastomer comprises a blend of a first elastomer and a second elastomer, the composition with the first elastomer and without the second elastomer having a melting point above about 110° C., and the composition with both the first elastomer and the second elastomer having a melting point below about 110° C.

36. The composition defined in claim 1 wherein the composition is a foamed rubbery gel comprising the gel as a continuous phase and further comprising a gas phase dispersed throughout the continuous phase.

37. The composition defined in claim 4 wherein the composition is a foamed gel comprising the gel as a continuous phase and further comprising a gas phase dispersed throughout the continuous phase.

38. A foam composition comprising a continuous phase and a dispersed gas phase, the continuous phase comprising:
a vegetable oil; and
a thermoplastic elastomer.

39. The composition defined in claim 38 wherein the thermoplastic elastomer comprises a rubber elastomer.

40. The composition defined in claim 38 wherein the vegetable oil comprises canola oil.

41. The composition defined in claim 38 wherein the thermoplastic elastomer is selected from the group consisting of diblock copolymers, triblock copolymers, and combinations thereof.

42. The composition defined in claim 3 8 wherein the thermoplastic elastomer is selected from the group consisting of diblock copolymers, triblock copolymers, and combinations thereof.

43. The composition defined in claim 38 wherein the foam composition is biodegradable.

44. The composition defined in claim 38 wherein the foam composition passes the Cal 117 test for nonflammability.

45. The composition defined in claim 44 wherein the dispersed gas phase is a fire retardant gas.

46. The composition defined in claim 4 wherein the vegetable oil is present in an amount within the range of from about 20% to about 75% by weight of the composition and the thermoplastic elastomer comprises a triblock copolymer which is present in an amount within the range of from about 25% to about 80% by weight of the composition.

47. A nonflowable composition comprising:
an oil;
a noncrosslinkable thermoplastic elastomer selected from the group consisting of diblock copolymers and triblock copolymers; and
a crosslinkable thermoplastic elastomer which is a block copolymer;
the nonflowable composition being characterized by its inability to flow when subjected to pressure.

48. A support surface for supporting the human body, comprising a foam composition and a holding structure for holding the foam composition, the foam composition comprising a continuous phase and a dispersed gas phase, the continuous phase comprising:
a vegetable oil; and
a thermoplastic elastomer.

49. A nonflammable gel composition comprising:
a vegetable oil;
a thermoplastic elastomer; and
a high temperature material having a melting point not greater than 105° C., the high temperature material being selected from the group consisting of high temperature waxes and high temperature plastics;
the nonflammable gel composition being characterized by its ability to pass the Cal 117 test for nonflammability.
